(19) United States
(12) Patent Application Publication
(10) Pub. No.: US 2015/0127447 A1
(43) Pub. Date: May 7, 2015

(54) METHOD AND APPARATUS FOR COUPON REDEMPTION BASED ON CONNECTIVITY AND SPATIAL CONFIGURATION

(71) Applicants: Dhaval Jitendra Joshi, Bangalore (IN); Hao Yang, San Jose, CA (US)

(72) Inventors: Dhaval Jitendra Joshi, Bangalore (IN); Hao Yang, San Jose, CA (US)

(73) Assignee: Nokia Corporation, Espoo (FI)

(21) Appl. No.: 14/398,287

(22) PCT Filed: May 15, 2012
(86) PCT No.: PCT/CN2012/075516

§ 371 Date: Dec. 4, 2014

(51) Int. Cl. G06Q 30/02; H04L 12/26; H04W 4/02; H04L 29/08

(52) U.S. Cl. CPC G06Q 30/0225; H04L 67/1095; H04L 43/08; H04W 4/02
USPC 705/14.26

(57) ABSTRACT

An approach is provided for validating redemption of a coupon. The coupon management module causes, at least in part, presentation of a coupon via a device. Next, the coupon management module receives a first code in response to the presentation. Next, the coupon management module causes, at least in part, validation of a redemption of the coupon based, at least in part, on the first code. The validation is performed at the device, at a server, or a combination thereof. Next, the coupon management module retrieves a second code based, at least in part, on the coupon, the first code, or a combination thereof. Next, the coupon management module causes, at least in part, presentation of the second code for verification. The validation of the redemption of the coupon is further based, at least in part, on the verification of the second code.

### BACKGROUND

Service providers and device manufacturers (e.g., wireless, cellular, electronic devices, etc.) are continually challenged to deliver value and convenience to consumers by, for example, providing compelling services in everyday lives. One area of interest has been use of coupons, and effective ways to process them. However, maintaining a record of when coupons are used or redeemed, particularly across multiple locations, can be quite challenging. For example, it can be resource intensive and burdensome for merchants or vendors to validate the coupons at the time of redemption, and then to keep track of which coupons have already been redeemed. This tracking can be used, for instance, to prevent overuse or misuse of the coupons as well as a monitor trends in purchases and coupon use. Accordingly, service providers and device manufacturers face significant technical challenges to provide efficient validation and tracking of coupon redemption or use.

### SOME EXAMPLE EMBODIMENTS

Therefore, there is a need for an approach for tracking and synchronizing coupon redemption.

According to one embodiment, a method comprises determining at least one redemption record for one or more coupons at one or more redemption devices. The method further comprises determining travel time information from the one or more redemption devices to one or more other redemption devices. The method further comprises determining an update order for causing, at least in part, a synchronization of the at least one redemption record to the one or more other redemption devices based, at least in part, on the travel time information.

According to another embodiment, an apparatus comprising at least one processor, and at least one memory including computer program code for one or more programs, the at least one memory and the computer program code configured to, with the at least one processor, cause, at least in part, the apparatus to determine at least one redemption record for one or more coupons at one or more redemption devices. The apparatus is further caused to determine travel time information from the one or more redemption devices to one or more other redemption devices. The apparatus is further caused to determine an update order for causing, at least in part, a synchronization of the at least one redemption record to the one or more other redemption devices based, at least in part, on the travel time information.

According to another embodiment, a computer-readable storage medium carrying one or more sequences of one or more instructions which, when executed by one or more processors, cause, at least in part, an apparatus to determine at least one redemption record for one or more coupons at one or more redemption devices. The apparatus is further caused to determine travel time information from the one or more redemption devices to one or more other redemption devices. The apparatus is further caused to determine an update order for causing, at least in part, a synchronization of the at least one redemption record to the one or more other redemption devices based, at least in part, on the travel time information.

According to another embodiment, an apparatus comprises means for determining at least one redemption record for one or more coupons at one or more redemption devices. The apparatus further comprises means for determining travel time information from the one or more redemption devices to one or more other redemption devices. The apparatus further comprises means for determining an update order for causing, at least in part, a synchronization of the at least one redemption record to the one or more other redemption devices based, at least in part, on the travel time information.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-20 and 36-38.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of tracking and synchronizing redemption of a coupon, according to one embodiment;

FIG. 2 is a diagram of the components of a coupon management platform, according to one embodiment;

FIG. 3 is a flowchart of a process for determining an update order for synchronizing coupon redemption records, according to one embodiment;

FIG. 4 is a flowchart of a process for determining an update order for synchronizing coupon redemption records based on whether redemption devices are co-located, according to one embodiment;

FIG. 5 is a flowchart of a process for synchronizing coupon redemption records in an offline mode, according to one embodiment;

FIG. 6 is a diagram of depicting an example of synchronizing coupon redemption records, according to one embodiment;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for coupon redemption based on connectivity and/or spatial configuration are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein the term “coupon” refers to a document, file, token, etc. that can be presented to receive a discount or rebate related to a transaction for goods and/or services. Although various embodiments are discussed with respect to negotiating and authenticating coupons, it is contemplated that the embodiments of the negotiating and authenticating process described herein are also applicable to any offers that can be negotiated and/or authenticated between users and/or vendors (e.g., service providers) including, but not limited, to physical and/or electronic coupons/offers for goods, services, other items in commerce, and the like.

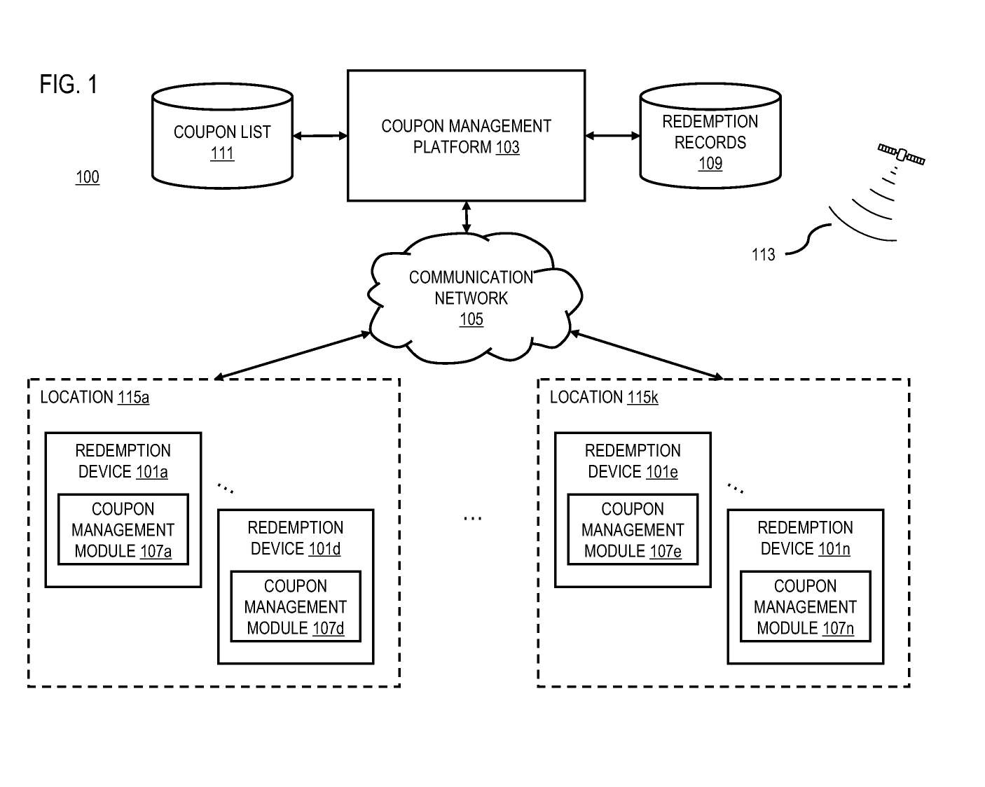

FIG. 1 is a diagram of a system capable of tracking and synchronizing redemption of a coupon, according to one embodiment. Coupon redemption can be a complex process that involves validating a coupon, verifying the details, and offering the right deal based on the details of the coupon. In addition, once the user presenting the coupon redeems the offered deal, a record of coupon redemptions can be maintained, for instance, to prevent overuse or misuse of coupons or provide coupon use information. By way of example, maintaining a record of the coupon redemption may enable recording an audit trail, such as the number of coupon redemptions, time/day of the redemption, redemption pattern and rewards, discounts or reconciliations provided by the coupons.

Further, if there is a third party involved in the coupon redemption, maintaining a record of the redemption may make it convenient to show the record to the third party. For example, if a manufacturer of an item issues coupons, and the retailer of the item may need to be reimbursed for giving discounts to the customer who presented the coupon, a record of the coupon redemption would be used as evidence for the reimbursement. Further, without a proper record of coupon redemption, fraud may occur when using coupons. For example, an employee may commit fraud by falsely claiming a coupon that a customer never claimed and taking cash from the register. As another example, a coupon may be redeemed more than once per customer (or more than the coupon is meant to be used), or the coupons may be illegally copied and distributed. In some cases, fraudulent users may attempt to modify the terms (e.g., a value) of a coupon and seek to redeem the altered coupon at the merchant.

Managing the coupon redemptions, maintaining the record of the redemptions, and preventing fraudulent use of coupons may be a laborious, time-consuming, and resource-intensive task. This problem can be particularly acute for multi-location merchants that can accept the same coupons at different locations because it can become very difficult to track which coupons have been validated and redeemed and which ones are not. In such a scenario, merchants may operate their redemption devices in an online mode whereby a redemption device seeking to validate/redeem a coupon would query other redemption devices to determine whether the coupon has already been used, redeemed, etc. over a data connection. In this scenario the data connection may be established on demand or established continuously. However, the resources and costs associated with maintaining such connections can be significant. For example, where a large number of coupons are being redeemed, the setup time for data connection with the server or other redemption devices as well as the time to transfer redemption information to and from the device can add up. For merchants or vendors, this added time can mean more time spent per customer, and for customers, it would mean more time just waiting to complete a transaction. This experience could be unpleasant or frustrating when the confirmation is delayed due to data connectivity issues. Such data connectivity issues can be even more problematic when network coverage is sparse (e.g., in emerging economies).

In another scenario, when a coupon is redeemed at one location, there is a possibility that the same coupon could be re-used at another redemption device at the same location or at another location after some time. Accordingly, service providers face significant challenges to ensuring that redemption records are synchronized throughout a merchant's network of redemption devices while also ensuring minimal resource usage and cost.

To address at least these problems, a system 100 of FIG. 1 introduces the capability to synchronize or update one or more coupon redemptions created at at least one coupon redemption device to one or more other coupon redemption devices based, at least in part, on estimated travel time from the originating redemption to the other coupon redemption devices. In other words, the system 100 can determine an update order or sequence for propagating or synchronizing coupon redemption records from one redemption device to another based on travel time. In one embodiment, the system 100 can prioritize updating of redemption devices that closest to the originating redemption devices first. In this way, the system 100 need not update all redemption devices simultaneously, which can tax available resources (e.g., bandwidth, processing resources, memory, etc.). Instead, the system 100, for instance, can update those redemption devices that are within the least amount of travel time from the originating redemption first and then subsequently update those redemption devices that are farther away with respect to travel time. As a result, the system 100 can reduce the potential resource burden and time associated with, for instance, simultaneous update of all redemption devices by targeting updates to those devices most likely to need the updated redemption records first (e.g., redemption devices within the least amount of travel time from the originating redemption device).

In one embodiment, system 100 may use distance or other spatial configuration of the redemption devices as a basis for determining travel time. By way of example, the system 100 may use distance as the sole factor by assuming that travel time has a direct correlation to the distance. In this scenario, distance can be used in place of travel time. The system 100, for instance, can base its update order for the redemption devices based solely on distance.

In other embodiments, the system 100 may use distance as one factor in computing travel time information among the redemption devices. More specifically, the system 100 may consider other factors such as available modes of transportation, terrain, traffic, routing conditions, environmental conditions, etc. that may affect the amount to timed needed to travel from one redemption device to another redemption device. The factors listed above are for illustration and are not intended to limit the factors that can be considered by the system 100 in determining travel time and ultimately an update order for synchronizing redemption records among the redemption devices.

As shown in FIG. 1, in one embodiment, the system 100 includes one or more redemption devices 101a-101n (also collectively referred to as redemption devices 101) with connectivity to a coupon management platform 103 over a communication network 105. The redemption devices 101a-101n may execute or include one or more respective coupon management modules 107a-107n (also collectively referred to as coupon management modules 107) for communicating with the coupon management platform 103 to enable synchronization of coupon redemption records 109 and/or coupon list 111 based on travel time estimation or distance between the redemption devices 101a-101n. In some embodiments, the coupon redemption records database 109 may be combined with the coupon list database 111 as a combined database.

In one embodiment, the coupon list database 111 includes a list coupons distributed by one or more merchants, vendors, etc. that may be redeemed at the redemption devices 101. By way of example, the coupon list database 111 includes, at least in part, an index of the distributed coupons. In some embodiments, the coupons are identified in the index using one or more identifiers (e.g., a numerical identifier such as a serial number). In addition, the coupon list 111 may include other information such as the terms or conditions of the deal (e.g., type of discount, amount of discount, etc.), validity information (e.g., dates, conditions, limitations, etc.), vendor information, and the like to support validation and/or redemption of the coupons in the coupon list 111.

In one embodiment, the coupon management platform 103 can configure the redemption devices 101 with local copies of the coupon list database 111. Once the coupon list 111 is configured, the redemption devices 101 need not maintain a network connection and can operate, for instance, in an offline mode. In one embodiment, when a consumer redeems a coupon at a particular redemption device 101, the redemption device 101 can create a redemption record for inclusion in the redemption records database 109. By way of example, the redemption record may identify the coupon (e.g., via a numerical or other identifier) and a location of the redemption. In one embodiment, the location of the redemption is determined from a location associated with the redemption device 101. For example, the redemption device 101 may include location sensors to interact with signals from the positioning satellites 113 to determine its location for the redemption record. It is contemplated that the redemption device may be configured with any location sensor or mechanism (e.g., cellular triangulation, WiFi location, etc.) for determining its location. In addition or alternatively, the location of the redemption device 101 may be manually configured (e.g., by the merchant or operator of the redemption device 101). For example, if the redemption device 101 is operated in a fixed or relatively fixed (e.g., have limited mobility such as only within a particular store), the operator need only specify a new location is the redemption device 101 is moved beyond a certain distance. In this way, the redemption device 101 need not have any location sensors or need not employ its location sensors unless the manually configured or previously configured location is no longer valid.

As noted above, in one embodiment, the redemption devices have local copies of the coupon list 111 and redemption records 109 that are updated while operating in an offline mode or limited update mode. Accordingly, the redemption devices 101 may synchronize the coupon list 111 and/or the redemption records 109 periodically to ensure that the redemption devices 101 have up-to-date information. In one embodiment, the system 100 performs the synchronization by selectively triggering an online mode of operation for the redemption devices 101. For example, the system 100 can determine when the number of un-synchronized redemptions meets a threshold value for the redemption devices 101. In other words, the redemption devices 101 can process a certain number of redemptions in an offline mode. Then when the number redemptions reaches the threshold, the redemption devices 101 are caused to enter an online mode to initiate the synchronization of the redemption records 109 and/or the coupon list 111. In one embodiment, the synchronization is performed according to the update order determined by the travel time (e.g., distance) between the redemption devices 101. The redemption devices 101 closest to the originating redemption 101, can be prioritized for updating first.

In one embodiment, the system 101 groups the redemption devices according to locations 115a-115k (also collectively referred to as locations 115). Each location 115a-115k, for instance, can correspond to a different merchant store location, and each redemption device 101a-101n within the respective locations 115a-115k can correspond, for instance, to a point-of-sale (POS) terminal or clerk. In one embodiment, the system 101 may determine whether a redemption device 101 that has redeemed a coupon is co-located with other redemption devices 101 at the same location 115. If there are co-located redemption devices 101, the system 101 can prioritize the local redemption devices 101 in the update order for synchronization. In some embodiments, the synchronization of the co-located redemption devices 101 (e.g., redemption device 101a-101d at location 115a) can occur using local connectivity means such as local adhoc connections. These ad-hoc connections may be based, for instance, on short range wireless connections (e.g., Bluetooth, WiFi, near field communications, etc.). In this way, the local synchronization need not rely on data connections over the communication network 105 which can potentially be more costly or not available. In one embodiment, the local synchronization may be configured to occur quickly after the redemption event to ensure that the same coupon cannot be redeemed by other redemption devices 101 within the same location 115 (e.g., store).

In some embodiments, the system 100 may prioritize the updating of other redemption devices 101 not co-located with the originating redemption device 101 following the local synchronization. For example, the system 101 may determine another location 115 that is closest to the location 115 associated with the originating redemption device 101, and include that redemption devices in the other location 115 first in the update order. The system 101 may then subsequently prioritize the other locations 115 based on the travel time or distance from the originating redemption device 101 or the location 115 associated with the originating redemption device 101.

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The redemption device 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), audio/video player, digital camera/camcorder, positioning device, television receiver, radio broadcast receiver, electronic book device, game device, or any combination thereof. It is also contemplated that the redemption device 101 can support any type of interface to the user (such as “wearable” circuitry, etc.). The redemption device 101 may also include input means such as keyboards, touch pads, touch screen buttons, clickable buttons, and etc., for entering code or commands associated with coupon validation and/or redemption.

By way of example, the redemption device 101 and the coupon management platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

In one embodiment, the coupon management module 107 and the coupon management platform 103 may interact according to a client-server model. According to the client-server model, a client process sends a message including a request to a server process, and the server process responds by providing a service (e.g., augmented reality image processing, augmented reality image retrieval, etc.). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

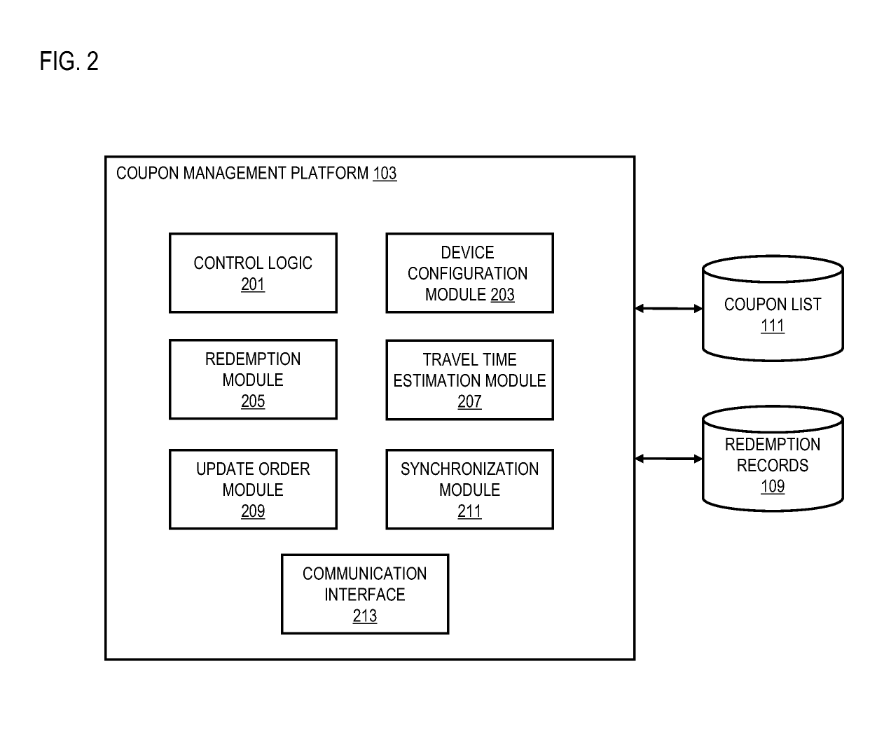

FIG. 2 is a diagram of the components of a coupon management platform, according to one embodiment. By way of example, the coupon management platform 103 includes one or more components provide for synchronization of coupon redemption records based on travel time or distance. It is contemplated that the functions of these components may be combined in one or more components or performed by other components of equivalent functionality. In addition or alternatively, in some embodiments, the coupon management module 107 of the redemption devices 101 may include all of some of the components described with respect to the coupon management platform 103.

In the example embodiment of FIG. 2, the coupon management platform 103 includes a control logic 201, a device configuration module 203, a redemption module 205, a travel time/distance estimation module 207, an update order module 209, a synchronization module 211, and a communication interface 213. In one embodiment, the control logic 201 is a means for executing and may execute at least one algorithm for performing one or more functions of the coupon management platform 103. For example, the control logic 201 may interact with the device configuration module 203 to configure one or more redemption devices 101 with an initial coupon list 111 and/or redemption records 109. In one embodiment, the device configuration module 203 transmits or otherwise conveys the coupon list 111 and/or redemption records 109 to the redemption 101 so that the redemption devices 101 may make local copies of the coupon list 111 and/or redemption records 109 for access while operating in an offline mode (e.g., a mode in which there is no network or data connectivity or a mode in which the network or data connectivity is not used for coupon redemption and/or validation).

Once the redemption devices 101 are configured, the redemption module 205 may provide means for determining or may determine when a coupon redemption record is created to indicate that a particular coupon has been redeemed or used. In one embodiment, the redemption record identifies, at least in part, the coupon that was redeemed (e.g., via a serial number or other identifier) and a location of the redemption. As described previously, the location sensors may be used to determine the location of the redemption device 101 at the time of redemption. In one embodiment, the redemption location can be determined by a triangulation system such as GPS, assisted GPS (A-GPS), Cell of Origin, or other location extrapolation technologies. Standard GPS and A-GPS systems can use satellites 113 to pinpoint the location of a redemption device 101. A Cell of Origin system can be used to determine the cellular tower that a cellular redemption device 101 is synchronized with. This information provides a coarse location of the redemption device 101 because the cellular tower can have a unique cellular identifier (cell-ID) that can be geographically mapped. The redemption device 101 may also utilize multiple technologies to determine its location. In one embodiment, the redemption location can be provided as GPS coordinates or a geo-code based on the GPS coordinates. In some embodiments, the GPS coordinates can include an altitude to provide a height. In other embodiments, the altitude can be determined using another type of altimeter or sensor.

Based on the determined redemption location, the travel time estimation module 207 may provide means for determining or may determine the locations of other redemption devices 101 that are associated with the a redemption device 101 originating a redemption record. For example, the location of the redemption devices 101 may be pre-configured at the coupon management platform 103 or may be reported (e.g., periodically, continuously, on demand, etc.) by the redemption devices to the coupon management platform 103. The travel time estimation module 207 then determines or otherwise estimates travel time information from the originating redemption device 101 to the other redemption devices. As previously described, in one embodiment, the travel time estimation module 207 may use distance or spatial configuration as a surrogate for estimating the travel time information. In other embodiments, the travel time estimation module 207 may take into account other factors such as routing information, available mode of transport, traffic conditions, terrain, environmental conditions, etc. to estimate travel time information. For example, even if one redemption device 101a is closer to the redemption location than another redemption device 101b, traffic conditions may make travel time less to redemption device 101b.

In some embodiments, the travel time estimation module 207 may interact with other navigation or mapping services or applications to determine the travel time information. For example, the travel time estimation module 207, via for instance an application programming interface (API), may transmit the redemption location and the locations of the redemption devices as respective starting and/or destination points for an external mapping or navigation service. The external mapping and/or navigation service may then return the travel time information. In addition, the travel estimation module 207 may configure, via the API, the external mapping or navigation service to consider additional factors in the travel time estimation (e.g., traffic, road conditions, etc.).

Based on the travel time or distance information for the redemption devices 101, the update order module 209 may provide means for determine or may determine an update order for synchronizing redemption records among the redemption devices 101. For example, the update order module 209 may prioritize updating of redemption devices 101 that are co-located with the originating redemption device 101 over those that are located at other merchant locations 115. The redemption devices 101 that are located at other merchant locations 115 may then be prioritized based on the travel time or distance information. For example, redemption devices 101 at with the shortest travel times or distances may be prioritized ahead of redemptions devices 101 farther away. In one embodiment, the update order module 209 may determine to batch the update or synchronization of the redemption devices 101 according to time. The update order module 209 may, for instance, update redemptions devices 101 in predetermined groups (e.g., groups of ten or some other number of devices). For example, the closest first ten redemption devices 101 may be scheduled for synchronization in a first update cycle, the next ten redemption devices 101 in a next update cycle, and so on. In one embodiment, the time between each update cycle may depend on the travel or distance from the redemption devices 101 in the previous update cycle. It is also contemplated that the grouping or updating of devices can be dependent on resource availability and/or resource use (e.g., available network connections, bandwidth, data size of redemption records to synchronize, etc.).

In one embodiment, the update order module 209 may then interact with the synchronization module 211 to initiate the synchronization of the coupon list 111 and/or the redemption records 109 according to the determined update order. In one embodiment, the synchronization module 211 may operate in a selective or triggered offline/online mode. More specifically, the synchronization module 211, in one embodiment, may determine when a threshold number of un-synchronized records (e.g., 10 records) have been created at any one of the redemption devices 101, and then cause the redemption devices 101 to enter an online mode for synchronization. It is contemplated that the threshold number may be configured based on, for instance, system resources, performance requirements, etc. In addition or alternatively, the synchronization module 211 may employ threshold criteria other than number of records to initiate the online state and synchronization (e.g., redemption record size, type of coupons, value of coupons, etc.). In one embodiment, following synchronization, the redemption devices are returned to an offline state.

In one embodiment, the synchronization of the redemption records is performed via the communication interface 213. By way of example, the communication interface 213 supports both local connectivity (e.g., via short range wireless) for synchronizing co-located redemption devices 101 as well as longer range connectivity (e.g., network or data connections over the communication network 105) to support synchronization of more distant or non-co-located redemption devices 101. In one embodiment, the local connectivity can be one or more ad-hoc connections (e.g., peer-to-peer connections, transient connections, etc.) among the redemption devices 101.

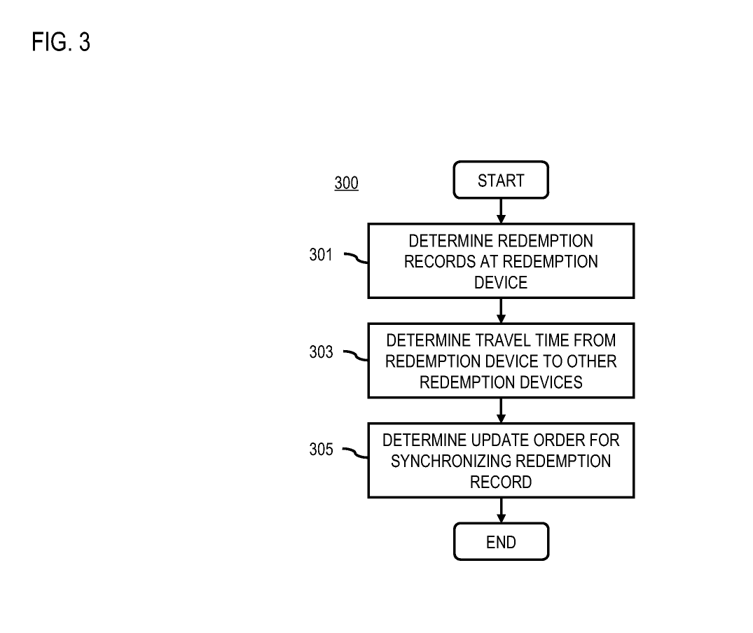

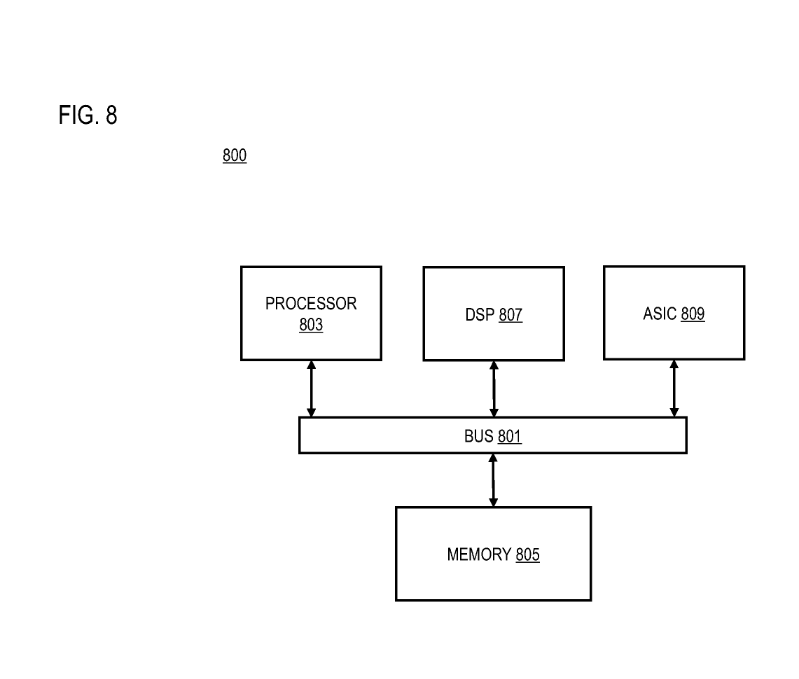

FIG. 3 is a flowchart of a process for determining an update order for synchronizing coupon redemption records, according to one embodiment. In one embodiment, the coupon management platform 103 performs the process 300 and is implemented in, for instance, a chip set including a processor and a memory as shown in FIG. 8. In addition or alternatively, the coupon management module 107 may perform all or a portion of the process 300.

In step 301, the coupon management platform 103 determines at least one redemption record for one or more coupons at one or more redemption devices 101. As described above, a redemption record is created when a user presents and redeems a coupon at a redemption device 101 for validation and/or redemption. In one embodiment, redemption includes a use of the coupon where a user is given a deal, offer, or other benefit as indicated in the coupon. In one embodiment, the coupon management platform 103 determines that a presented coupon is contained in its local copy of the coupon list 111. This determination is made, for instance, by determining whether the identifier (e.g., a serial number) obtained from the presented coupon has an equivalent entry in the coupon list 111. In one embodiment, the coupon list 111 contains records for coupons issued or otherwise valid for redemption at one or more merchants.

By way of example, the coupon list 111 is an index listing the identifiers (e.g., a numeric identifier such as a serial number) associated with the coupons. In one embodiment, when a coupon is redeemed, the redemption device 101 flags the corresponding coupon record in the coupon list 111 as “redeemed”, “used”, or other equivalent qualifier. In addition, the redemption device 101 adds a redemption location to the record. In some embodiments, the redemption record may be maintained in the coupon list 111 or maintained in a separate redemption records database 109.

Next, the coupon management platform 103 determines travel time information from the one or more redemption devices 101 to one or more other redemption devices 101 (step 303). This travel time information, for instance, is determined with the redemption location specified in the redemption record as a reference point. In one embodiment, the coupon management platform 103 determines the travel time information based, at least in part, on distance information from the one or more redemption devices to the one or more other redemption devices. In other words, the coupon management platform 103 can use distance as the sole factor in determining or estimating travel time.

In other embodiments, the coupon management platform 103 may use distance as one factor in determining travel time information. For example, the coupon management platform 103 can determine the travel time information based, at least in part, on routing information from the one or more redemption devices to one or more other redemption devices. As used in mapping and/or navigation service or applications, routing information takes account the distance between starting points, way points, and/or destinations to calculate a route or path between the points. Because routing information can account for a variety of factors, such information can potentially provide for more accurate estimates of how long it would take a coupon user to move from redemption location to another. In some embodiments, the coupon management platform 103 determines contextual information (e.g., time of day, season, weather, environmental conditions, traffic, accidents, special events, etc.), mode of transport information, or a combination thereof associated with the routing information, wherein the travel time information is further based, at least in part, on the contextual information, the mode of transport information, or a combination thereof.

This travel time can therefore provide an indication of how quickly and/or in what order redemption devices 101 should be updated to avoid potential misuse or reuse of the coupon by the coupon user, particularly when continuous or simultaneous updating of all redemption devices 101 is not feasible given resource and/or cost constraints. Accordingly, in step 305, the coupon management platform 103 determines an update order for causing, at least in part, a synchronization of the at least one redemption record to the one or more other redemption devices 101 based, at least in part, on the travel time information.

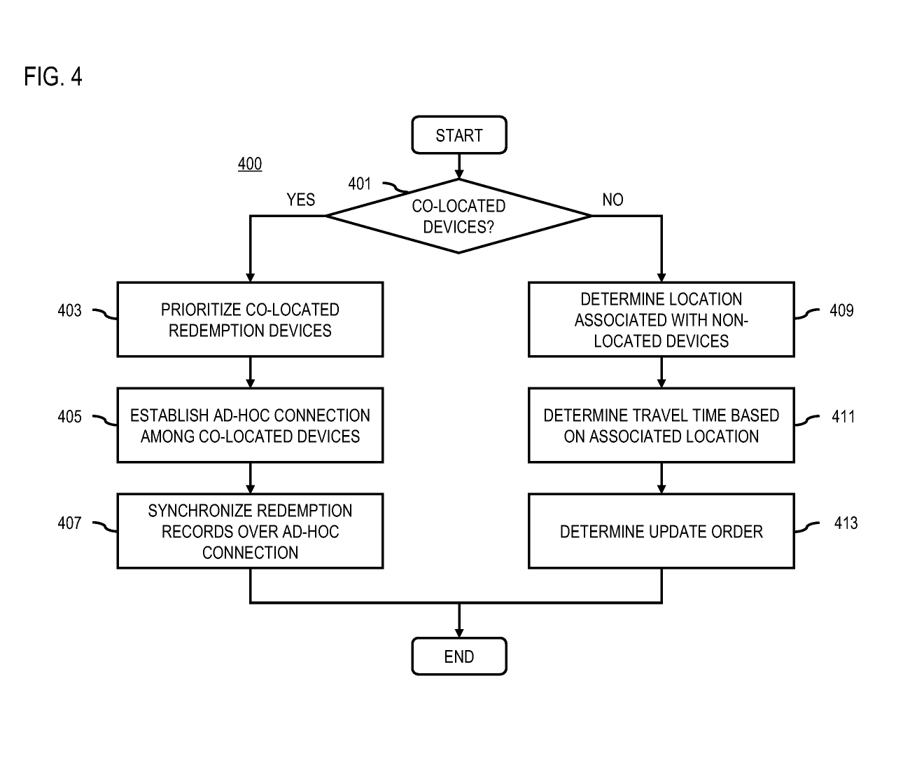

FIG. 4 is a flowchart of a process for determining an update order for synchronizing coupon redemption records based on whether redemption devices are co-located, according to one embodiment. In one embodiment, the coupon management platform 103 performs the process 400 and is implemented in, for instance, a chip set including a processor and a memory as shown in FIG. 8. In addition or alternatively, the coupon management module 107 may perform all or a portion of the process 400.

In step 401, the coupon management platform 103 determines whether the one or more redemption devices 101, the one or more other redemption devices 101, or a combination thereof that are to be updated are co-located. By way of example, co-location indicates that the redemption devices 101 are installed or used within a common location such as a merchant store. In one embodiment, the coupon management platform 103 may determine the criteria or rules for determining whether the redemption devices 101 are co-located. For example, for a determination of co-location, the coupon management platform 103 may specify that the redemption devices 101 are within a physical boundary, within ad-hoc connectivity range, have line-of-sight, or any other criteria.

If the coupon management platform 103 determines that at least one of the one or more other redemption devices 101 is co-located with the one or more redemption devices 101 (e.g., the originating redemption device 101 with the unsynchronized redemption record), the coupon management platform 103 causes, at least in part, a prioritization of the at least one co-located other redemption device in the update order (step 403). This prioritization may include scheduling or initiating an update of the co-located redemption devices 101 first so that a coupon user can be prevented from attempting to redeem the same coupon at another redemption device 101 before the redemption records have had a chance to be updated to redemptions devices 101 within the same store.

To facilitate the updating of co-located redemption devices 101, the coupon management platform 103 then causes, at least in part, an establishment of an ad-hoc connectivity session between the one or more coupon redemption devices and the at least one co-located other coupon redemption device (step 405). By way of example, ad-hoc connectivity sessions can be based on short range wireless technology (e.g., Bluetooth, WiFi, near field communications, etc.). Typically these ad-hoc sessions can be created at little to no cost when compared to establishing a data connection over the communication network 105 via a service provider. In step 407, the coupon management platform 103 causes, at least in part, a synchronization of the at least one redemption record to the at least one co-located other coupon redemption device via the ad-hoc connectivity session.

If the coupon management platform 103 determines that at least one of the one or more other redemption devices 101 is not co-located with the one or more redemption devices 101, the coupon management platform 103 determines at least one location associated with the at least one non-co-located other redemption device 101 (step 409). In one embodiment, the at least one location (e.g., location 115) represents a store or physical place of business were redemption devices 101 are installed or operated. As described with respect to FIG. 1, merchants often have multiple locations 115 containing multiple redemption devices 101. The coupon management platform 103 then determines the travel time information is determined from the one or redemption devices to the at least one location (step 411). Accordingly, the redemption location for any redemption records created by a redemption device, for instance, can be assumed or estimated to be the location of the merchant's store or chain of stores. In one embodiment, the at least one location is associated with at least one vendor or merchant that accepts the one or more coupons. The coupon management platform 103 then determines the update order for synchronizing the redemption devices 101 based on the travel time information as previously described (step 413).

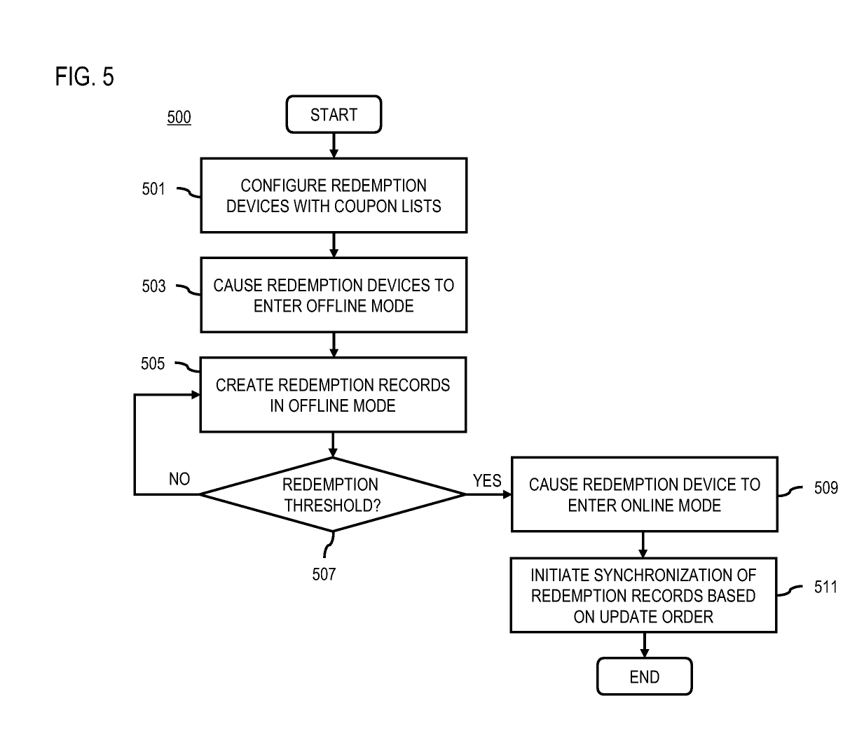

FIG. 5 is a flowchart of a process for synchronizing coupon redemption records in an offline mode, according to one embodiment. In one embodiment, the coupon management platform 103 performs the process 500 and is implemented in, for instance, a chip set including a processor and a memory as shown in FIG. 8. In addition or alternatively, the coupon management module 107 may perform all or a portion of the process 500.

In one example scenario, a chain of stores issues a series of coupons and distributes them using multiple third party services and/or applications. This list of coupons can be stored in, for instance, the coupon list 111. By way of example, this chain of stores could have any number of redemption devices 101 across is multiple locations 115 or stores. FIG. 5 describes a process 500 for setting up the redemption devices for this chain of stores. In one embodiment, the process 500 may be performed as a first setup process or when the redemption devices initialized. In step 501, the coupon management platform 103 causes, at least in part, a configuration of the one or more redemption devices 101, the one or more other redemption devices 101, or a combination thereof with a list 111 of the one or more coupons. In one embodiment, the list 111 associates the one or more coupons with respective one or more coupon identifiers (e.g., a numeric identifier such as a serial number).

In step 503, the coupon management platform 103 determines to cause, at least in part, the one or more redemption devices 101, the one or more other redemption devices 101, or a combination thereof to enter an offline mode following the configuration. In one embodiment, the redemption devices 101 then create the redemption records while operating in the offline mode (step 505). By way of example, operating in an offline mode enables the merchant to avoid the connectivity costs or resource burdens associated with maintain more frequent or continuous data connections. As previously discussed, in one embodiment, the redemption records specify at least one of the one or more coupon identifiers and at least one redemption location.

In step 507, the coupon management platform 103 determines whether a threshold for initiating a synchronization of the redemption records is reached. If no, the process 500 returns to step 505 where the redemption devices 101 await for coupon redemption requests to create additional redemption records. If yes, the coupon management platform 103 determines to cause, at least in part, the one or more redemption devices 101, the one or more other redemption devices 101, or a combination thereof to enter an online mode based, at least in part, on a threshold value for a number of the at least one redemption record (step 509). In other words, the redemption devices 101 can buffer the redemption records up to a certain number before communicating or synchronizing the redemptions records (e.g., to the coupon management platform 103). In addition or alternatively, the redemption devices 101 may communicate or synchronize the redemption records at preset time intervals. The coupon management platform 103 then causes, at least in part, an initiation of the synchronization of the at least one redemption record among the one or more redemption devices, the one or more other redemption devices, or a combination thereof based, at least in part, on the update order (step 511).

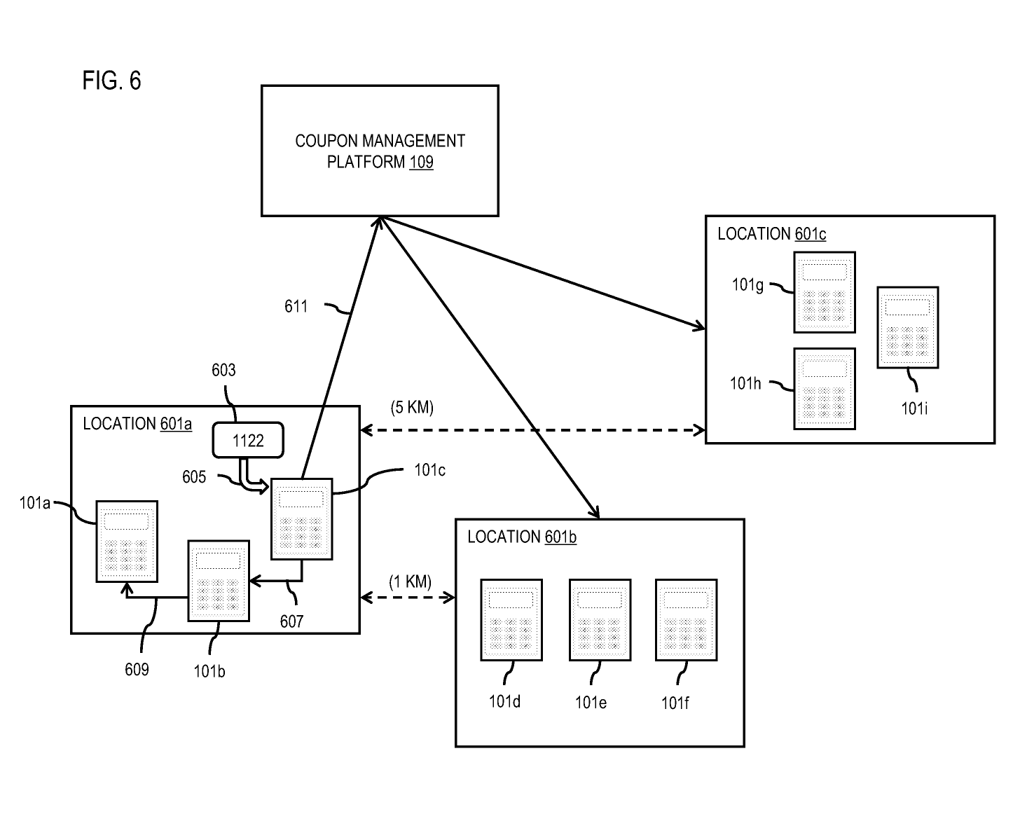

FIG. 6 is a diagram of depicting an example of synchronizing coupon redemption records, according to one embodiment. As shown in FIG. 6, a merchant operates three locations 601a-601c in which three each of respective redemption devices 101a-101b are located. In this example, the distance between location 601a and 601b is 1 km, and the distance between location 601a and 601c is 5 km.

At location 601a, a coupon 603 with the identifier “1122” is presented at redemption device 101c. In a process 605, the redemption device 101c validates and creates a redemption record for coupon 603 that it has been redeemed or used. The redemption record includes the location of the redemption device 101c (e.g., location 601a) as the redemption location. The redemption device 101c (e.g., via a coupon management module 107c) then determines an update order for synchronizing the redemption record for coupon 603 by first prioritizing the update of co-located redemption devices 101b and 101a. In this case, the redemption device 101b is closest to the originating redemption device 101c. Accordingly, the redemption device 101c establishes an ad-hoc connectivity session (e.g., Bluetooth connection) with the redemption device 101b to synchronize the redemption record for coupon 603 in a process 607. Similarly, the redemption device 101b, which has now been updated, determines that is closest to redemption device 101a. The redemption device 101b then establishes an ad-hoc connectivity session with the redemption 101a to further propagate the redemption record for coupon 603 to the redemption device 101a in a process 609. After completion of the process 609, all redemption devices 101a-101c at location 601a are now up-to-date, thereby reducing the potential that a customer can reuse coupon 603 at another redemption device 101b or 101a at location 601a.

Next, in a process 611, the redemption device 101c synchronizes the redemption record for coupon 603 to the coupon management platform 103. The coupon management platform 103 can then determine the travel time or distance to the next closest location 601b (e.g., located 1 km away from location 601a). The coupon management platform 103 then determines an update order in which the redemption devices 101d-101f of location 601b are next to be updated or synchronized with the redemption record for coupon 603. In one embodiment, the coupon management platform 103 can attempt to schedule or initiate the synchronization of the redemption record to the location 601b before the estimated travel time to reach the location 601b from location 601a. For example, if the only mode of transportation available from location 601a to location 601b is by walking at 4 km/hr. The coupon management platform 103 can estimate a travel time for the 1 km distance at 15 mins. As a result, the coupon management platform 103 can schedule an update for location 601b within 15 mins of the redemption time for coupon 603 in a process 613. Because location 601c is even farther away from location 601a at 5 km, the coupon management platform 103 can prioritize the update order for the redemption devices 101g-101i at location 601c last in a process 615.

The processes described herein for synchronizing coupon redemption records are advantageous because distance- or travel time-based updates or synchronization reduces the potential for fraudulent coupon reuse while minimizing resource burdens and/or costs. The various embodiments apply to co-located (e.g., in the same store) redemption devices 101, redemption devices 101 in nearby stores, and redemption devices 101 in faraway stores where the coupon management platform 103 can be configured to provide updates before a potential can travel to the other stores. This approach can help to ensure that the coupon management platform 103 has enough time and resources to update each location 115 and/or redemption device 101 quickly and efficiently. This approach also can be used in high volume coupon redemption where many locations are synchronized in a short period of time.

The processes described herein for synchronizing coupon redemption records may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

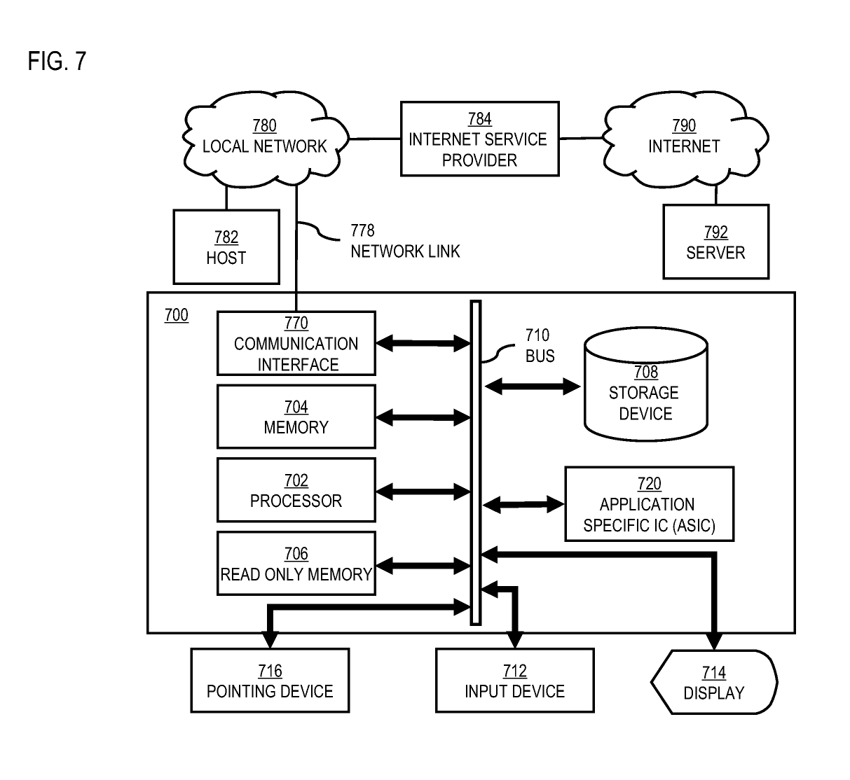

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to synchronize coupon redemption records as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of synchronizing coupon redemption records.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to synchronizing coupon redemption records. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for synchronizing coupon redemption records. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for synchronizing coupon redemption records, is provided to the bus 710 for use by the processor from an external input device 712, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for synchronizing coupon redemption records.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to synchronize coupon redemption records as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of synchronizing coupon redemption records.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to synchronize coupon redemption records. The memory 805 also stores the data associated with or generated by the execution of the inventive steps.

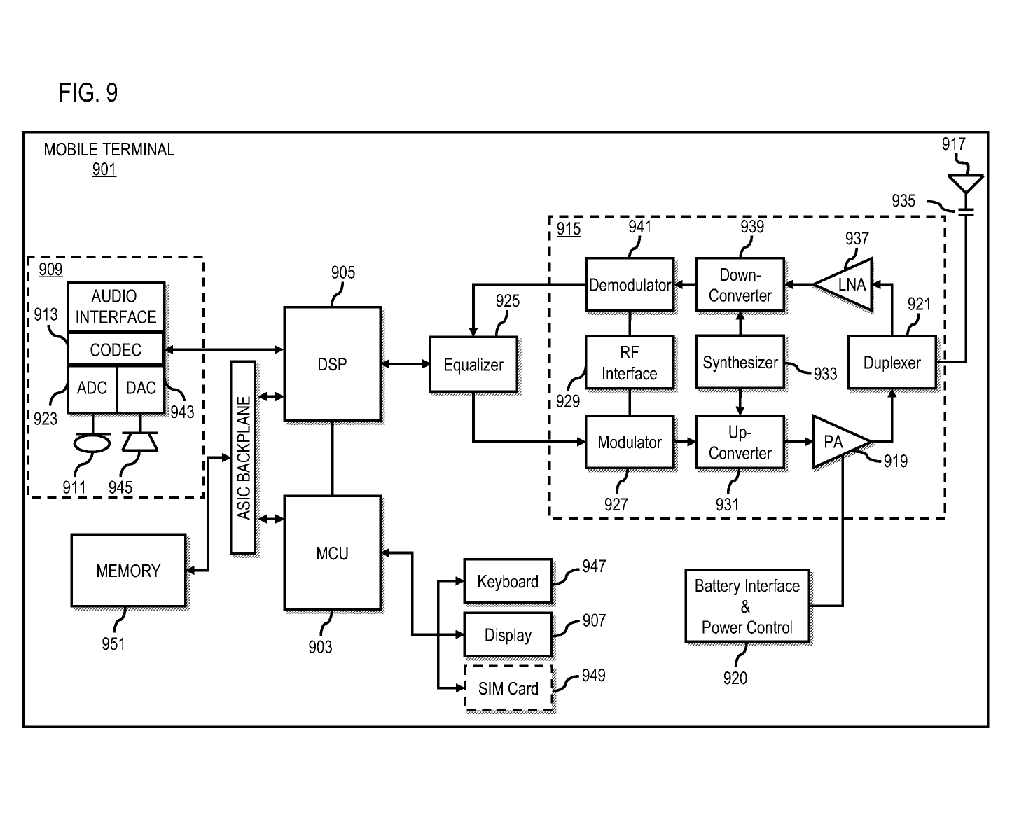

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of synchronizing coupon redemption records. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of synchronizing coupon redemption records. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to synchronize coupon redemption records. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-53. (canceled)

54. A method comprising facilitating a processing of and/or processing (1) data and/or (2) information and/or (3) at least one signal, the (1) data and/or (2) information and/or (3) at least one signal based, at least in part, on the following:
at least one determination of at least one redemption record for one or more coupons at one or more redemption devices;
at least one determination of travel time information from the one or more redemption devices to one or more other redemption devices; and
at least one determination of an update order for causing, at least in part, a synchronization of the at least one redemption record to the one or more other redemption devices based, at least in part, on the travel time information.

55. The method of claim 54, wherein the (1) data and/or (2) information and/or (3) at least one signal are further based, at least in part, on the following:
at least one determination of the travel time information based, at least in part, on routing information from the one or more redemption devices to one or more other redemption devices,
at least one determination of contextual information, mode of transport information, or a combination thereof associated with a routing information,
wherein the travel time information is further based, at least in part, on the contextual information, the mode of transport information, or a combination thereof.

56. The method of claim 54, wherein the (1) data and/or (2) information and/or (3) at least one signal are further based, at least in part, on the following:
at least one determination of that at least one of the one or more other redemption devices is co-located with the one or more redemption devices; and
a prioritization of the at least one co-located other redemption device in the update order.

57. The method of claim 56, wherein the (1) data and/or (2) information and/or (3) at least one signal are further based, at least in part, on the following:
an establishment of an ad-hoc connectivity session between the one or more coupon redemption devices and the at least one co-located other coupon redemption device; and
a synchronization of the at least one redemption record to the at least one co-located other coupon redemption device via the ad-hoc connectivity session.

58. The method of claim 54, wherein the (1) data and/or (2) information and/or (3) at least one signal are further based, at least in part, on the following:
at least one determination of that at least one of the one or more other redemption devices is not co-located with the one or more redemption devices; and
at least one determination of at least one location associated with the at least one non-co-located other redemption device,
wherein the travel time information is determined from the one or redemption devices to the at least one location.

59. The method of claim 54, wherein the (1) data and/or (2) information and/or (3) at least one signal are further based, at least in part, on the following:
at least one determination of that the one or more redemption devices, the one or more other redemption devices, or a combination thereof are in an online mode; and
an initiation of the synchronization during the online mode.

60. The method of claim 59, wherein the one or more redemption devices, the one or more other redemption devices, or a combination thereof enter or exit the online mode according to a redemption threshold criterion, a schedule, periodically, on demand, or a combination thereof.

61. An apparatus comprising:
at least one processor; and
at least one memory including computer program code for one or more programs,
the at least one memory and the computer program code configured to, with the at least one processor, cause the apparatus to perform at least the following,
determine at least one redemption record for one or more coupons at one or more redemption devices;
determine travel time information from the one or more redemption devices to one or more other redemption devices; and
determine an update order for causing, at least in part, a synchronization of the at least one redemption record to the one or more other redemption devices based, at least in part, on the travel time information.

62. The apparatus of claim 61, wherein the apparatus is further caused to:
determine the travel time information based, at least in part, on routing information from the one or more redemption devices to one or more other redemption devices,
determine contextual information, mode of transport information, or a combination thereof associated with the routing information,
wherein the travel time information is further based, at least in part, on the contextual information, the mode of transport information, or a combination thereof.

63. The apparatus of claim 61, wherein the apparatus is further caused to:
determine that at least one of the one or more other redemption devices is co-located with the one or more redemption devices; and
cause, at least in part, a prioritization of the at least one co-located other redemption device in the update order.

64. The apparatus of claim 63, wherein the apparatus is further caused to:
cause, at least in part, an establishment of an ad-hoc connectivity session between the one or more coupon redemption devices and the at least one co-located other coupon redemption device; and
cause, at least in part, a synchronization of the at least one redemption record to the at least one co-located other coupon redemption device via the ad-hoc connectivity session.

65. The apparatus of claim 61, wherein the apparatus is further caused to:
determine that at least one of the one or more other redemption devices is not co-located with the one or more redemption devices; and
determine at least one location associated with the at least one non-co-located other redemption device,
wherein the travel time information is determined from the one or redemption devices to the at least one location.

66. The apparatus of claim 61, wherein the apparatus is further caused to:
determine that the one or more redemption devices, the one or more other redemption devices, or a combination thereof are in an online mode; and
cause, at least in part, an initiation of the synchronization during the online mode.

67. The apparatus of claim 66, wherein the one or more redemption devices, the one or more other redemption devices, or a combination thereof enter or exit the online mode according to a redemption threshold criterion, a schedule, periodically, on demand, or a combination thereof.

68. The apparatus of claim 61, wherein the apparatus is further caused to:
cause, at least in part, a configuration of the one or more redemption devices, the one or more other redemption devices, or a combination thereof with a list of the one or more coupons,
wherein the list associates the one or more coupons with respective one or more coupon identifiers.

69. The apparatus of claim 61, wherein the at least one redemption record specifies at least one of the one or more coupon identifiers and at least one redemption location.

70. The apparatus of claim 69, wherein the apparatus is further caused to:
determine to cause, at least in part, the one or more redemption devices, the one or more other redemption devices, or a combination thereof to enter an offline mode following the configuration.

71. The apparatus of claim 70, wherein the apparatus is further caused to:
determine to cause, at least in part, the one or more redemption devices, the one or more other redemption devices, or a combination thereof to enter an online mode based, at least in part, on a threshold value for a number of the at least one redemption record.

72. The apparatus of claim 71, wherein the apparatus is further caused to:
cause, at least in part, an initiation of the synchronization of the at least one redemption record among the one or more redemption devices, the one or more other redemption devices, or a combination thereof based, at least in part, on the update order.

73. A method comprising:
determining at least one redemption record for one or more coupons at one or more redemption devices;
determining travel time information from the one or more redemption devices to one or more other redemption devices; and
determining an update order for causing, at least in part, a synchronization of the at least one redemption record to the one or more other redemption devices based, at least in part, on the travel time information.
